(19) United States
(12) Patent Application Publication
(10) Pub. No.: US 2013/0077090 A1
(43) Pub. Date: Mar. 28, 2013

(54) IMAGE SENSORS AND IMAGE PROCESSING SYSTEMS INCLUDING THE SAME

(71) Applicant: Samsung Electronics Co., Ltd., Suwon-si (KR)

(72) Inventor: Jung Chak AHN, Yongin-si (KR)

(73) Assignee: SAMSUNG ELECTRONICS CO., LTD., Suwon-Si (KR)

(21) Appl. No.: 13/628,586

(22) Filed: Sep. 27, 2012

(30) Foreign Application Priority Data
Sep. 27, 2011 (KR) 10-2011-0097790

(51) Int. Cl. G01J 1/00

(52) U.S. Cl. 356/213

(57) ABSTRACT

An image sensor may include a plurality of filters; and an air gap region positioned between the plurality of filters, an index of refraction of each of the filters is greater than an index of refraction of the air gap region.

### CROSS-REFERENCE TO RELATED APPLICATION(S)

This application claims priority from Korean Patent Application No. 10-2011-0097790, filed on Sep. 27, 2011, in the Korean Intellectual Property Office (KIPO), the entire contents of which are incorporated herein by reference.

### BACKGROUND

1. Field

Some example embodiments of the inventive concept may relate to image sensors. Some example embodiments may relate to image sensors for increasing signal-to-noise ratios (SNR) and/or image processing systems including the same.

2. Description of Related Art

Image sensors are devices that convert an optical signal into an electrical signal. Image sensors are divided into charge-coupled device (CCD) image sensors and complementary metal oxide semiconductor (CMOS) image sensors (CISs).

Since CISs are easier to be driven, enable integration of a signal processing circuit, can be miniaturized, need lower manufacturing cost, and have lower power consumption than CCD image sensors, CISs are widely used in various fields. CISs include a metal oxide semiconductor (MOS) transistor in each pixel of a pixel array and output a sensed image signal using a switching operation of the MOS transistor.

### SUMMARY

In some example embodiments, an image sensor may comprise a plurality of filters; and an air gap region positioned between the plurality of filters, wherein an index of refraction of each of the filters is greater than an index of refraction of the air gap region.

In some example embodiments, the image sensor may further comprise a first passivation layer formed on the filters to protect the filters.

In some example embodiments, the first passivation layer has an index of refraction greater than the index of refraction of the filters.

In some example embodiments, the first passivation layer is an oxide layer, a nitride layer, or a photoresist layer.

In some example embodiments, the air gap region has widths greater than or equal to 100 nm and less than or equal to 300 nm.

In some example embodiments, the image sensor does not include microlens.

In some example embodiments, the image sensor may further comprise a second passivation layer formed on the first passivation layer.

In some example embodiments, the second passivation layer has an index of refraction greater than the index of refraction of the filters.

In some example embodiments, the second passivation layer is an oxide layer, a nitride layer, or a photoresist layer.

In some example embodiments, the air gap region has widths less than or equal to 300 nm.

In some example embodiments, the index of refraction of the air gap region is 1.

In some example embodiments, the index of refraction of the filters is greater than 1.

In some example embodiments, the index of refraction of the filters is less than or equal to 1.7.

In some example embodiments, an image processing system, comprises an image sensor, and a processor configured to control operation of the image sensor, wherein the image sensor comprises, a plurality of filters; and an air gap region positioned between the plurality of filters, wherein an index of refraction of each of the filters is greater than an index of refraction of the air gap region.

In some example embodiments, the image processing system is a portable device.

In some example embodiments, the image processing system is a mobile communication device.

In some example embodiments, the image sensor further comprises a first passivation layer formed on the filters to protect the filters.

In some example embodiments, the image sensor further comprises a second passivation layer formed on the first passivation layer.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a schematic block diagram of an image processing system including a pixel array according to some example embodiments of the inventive concept;

FIG. 2 is a cross-sectional view of a plurality of active pixels included in the pixel array of an image sensor included in FIG. 1, according to some example embodiments of the inventive concept;

FIG. 3 is a cross-sectional view of a plurality of active pixels included in the pixel array of the image sensor included in FIG. 1, according to some example embodiments of the inventive concept;

FIG. 4 is a cross-sectional view of a plurality of active pixels included in the pixel array of the image sensor included in FIG. 1, according to some example embodiments of the inventive concept;

FIG. 5 is a cross-sectional view of a plurality of active pixels in the pixel array of the image sensor included in FIG. 1, according to some example embodiments of the inventive concept;

FIG. 6 is a cross-sectional view of a plurality of active pixels in the pixel array of the image sensor included in FIG. 1, according to some example embodiments of the inventive concept;

FIG. 7 is a cross-sectional view of a plurality of active pixels in the pixel array of the image sensor included in FIG. 1, according to some example embodiments of the inventive concept;

FIG. 8 is a detailed block diagram of the image sensor illustrated in FIG. 1; and

FIG. 9 is a schematic block diagram of an image processing system including an image sensor according to some example embodiments of the inventive concept.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

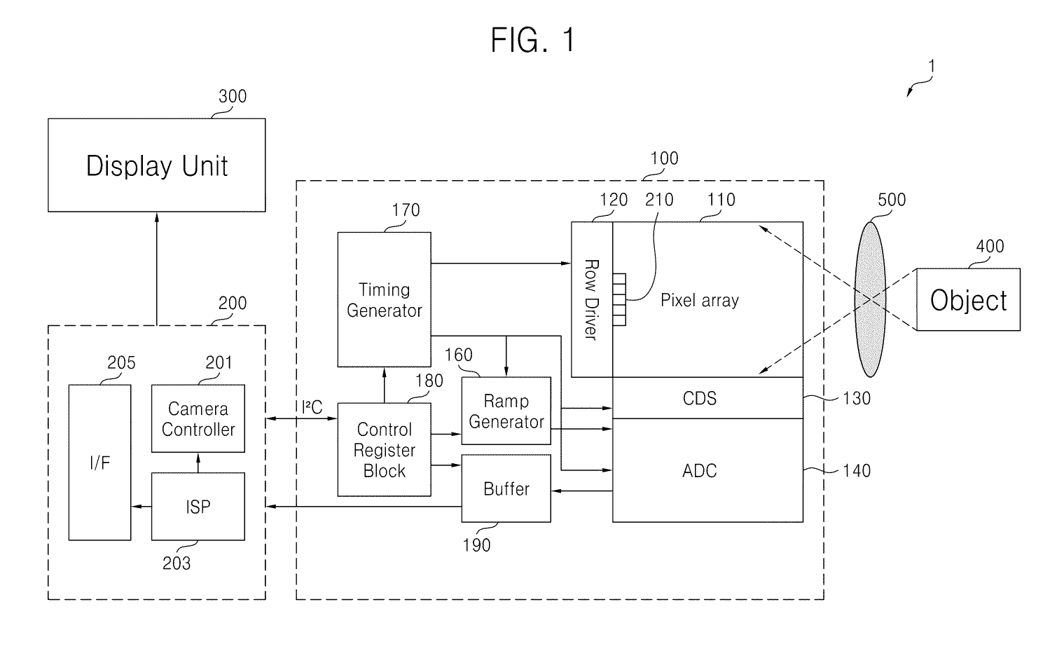

FIG. 1 is a schematic block diagram of an image processing system 1 including a pixel array 110 according to some example embodiments of the inventive concept. Referring to FIG. 1, the image processing system 1 includes an image sensor 100, a digital signal processor (DSP) 200, a display unit 300, and a lens module 500.

The image sensor 100 includes a pixel array 110, a row driver 120, a correlated double sampling (CDS) block 130, an analog-to-digital converter (ADC) block 140, a ramp generator 160, a timing generator 170, a control register block 180, and a buffer 190.

In some example embodiments, an image sensor may be implemented by a back-illuminated (BI) or backside illumination (BSI) image sensor.

The image sensor 100 senses an optical image of an object 400 picked up through the lens module 500 according to the control of the DSP 200. The DSP 200 may output an image, which has been sensed and output by the image sensor 100, to the display unit 300. At this time, the display unit 300 may be any device that can display an image output from the DSP 200. For instance, the display unit 300 may be a computer, a mobile communication device, or a terminal of an image output device.

The DSP 200 includes a camera controller 201, an image signal processor (ISP) 203, and an interface (I/F) 205.

The camera controller 201 controls the operation of the control register block 180. The camera controller 201 may control the image sensor 100, and more specifically, the control register block 180 using an inter-integrated circuit (I²C), but example embodiments of the inventive concept are not restricted thereto.

The ISP 203 receives an image or image data from the buffer 190, processes the image to be nice for people to look at, and outputs the processed image to the display unit 300 through the OF 205.

Although the ISP 203 is positioned within the DSP 200 in the example embodiments illustrated in FIG. 1, the ISP 203 may be positioned within the image sensor 100 in some example embodiments. The image sensor 100 and the ISP 203 may be integrated into a single package, e.g., a multi-chip package (MCP). The pixel array 110 includes a plurality of active pixels 210.

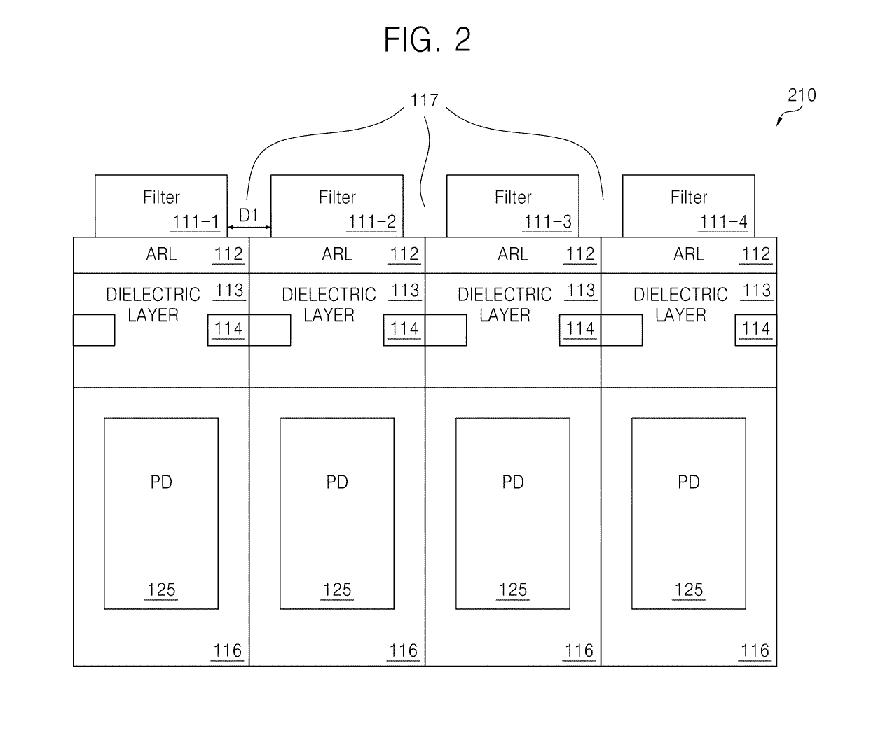

FIG. 2 is a cross-sectional view of a plurality of the active pixels 210 included in the pixel array 110 of the image sensor 100 included in FIG. 1, according to some example embodiments of the inventive concept.

Referring to FIGS. 1 and 2, the active pixels 210 include a plurality of filters 111-1, 111-2, 111-3, and 111-4, respectively, an antireflection film (ARF) or an antireflection layer(hereafter referred as ARL) 112, a dielectric layer 113, a metal 114, and a substrate 116. Although four active pixels 210 are illustrated for convenience' sake in the description, example embodiments of the inventive concept are not restricted thereto.

Each of the filters 111-1, 111-2, 111-3, and 111-4 is disposed on the ARL 112 to focus incident light. The ARL 112 is used to reduce reflection. The filters 111-1, 111-2, 111-3, and 111-4 may be separated from one another by an air gap region 117. The index of refraction of the filters 111-1, 111-2, 111-3, and 111-4 is greater than that of the air gap region 117, i.e., air. For instance, when the index of refraction of the air gap region 117 is 1, the index of refraction of the filters 111-1, 111-2, 111-3, and 111-4 may be greater than 1 and not exceed 1.7. Because of the refraction difference between the air gap region 117 and the filter 111-1, 111-2, 111-3 or 111-4, the active pixels 210 do not require additional microlens to focus incident light.

A width D1 of the air gap region 117 formed between the filters 111-1, 111-2, 111-3, and 111-4 may be at least 100 nm and at most 300 nm. The width D1 of the air gap region 117 may be 200 nm.

The filters 111-1, 111-2, 111-3, and 111-4 may be implemented by a color filter transmitting wavelengths in the visible spectrum or an infrared filter transmitting wavelengths in the infrared spectrum.

For instance, the color filter may be a red filter transmitting wavelength in the red range of the visible spectrum, a green filter transmitting wavelength in the green range of the visible spectrum, or a blue filter transmitting wavelength in the blue range of the visible spectrum.

Alternatively, the color filter may be a cyan filter, a yellow filter, or a magenta filter.

The ARL 112 prevents light, which has come in through the filters 111-1, 111-2, 111-3, and 111-4, from being reflected or reduces the amount of reflection. The ARL 112 may be formed of nitric oxide to a thickness of 400 Å to 500 Å.

The dielectric layer 113 is formed between the filters 111-1, 111-2, 111-3, and 111-4 and the substrate 116. The dielectric layer 113 may be formed of an oxide layer or a composite layer of an oxide layer and a nitride layer. Electrical wiring necessary for a sensing operation of the active pixels 210 may be formed by the metal 114. The metal 114 is partially removed using heat treatment in order to transmit light.

The photo electric conversion device 125 may generate photoelectrons in response to light incident from an external source. The photo electric conversion device 125 is formed in the substrate 116. The photo electric conversion device 125 is a photosensitive element and may be implemented by using a photodiode, a phototransistor, a photogate, or a pinned photodiode (PPD).

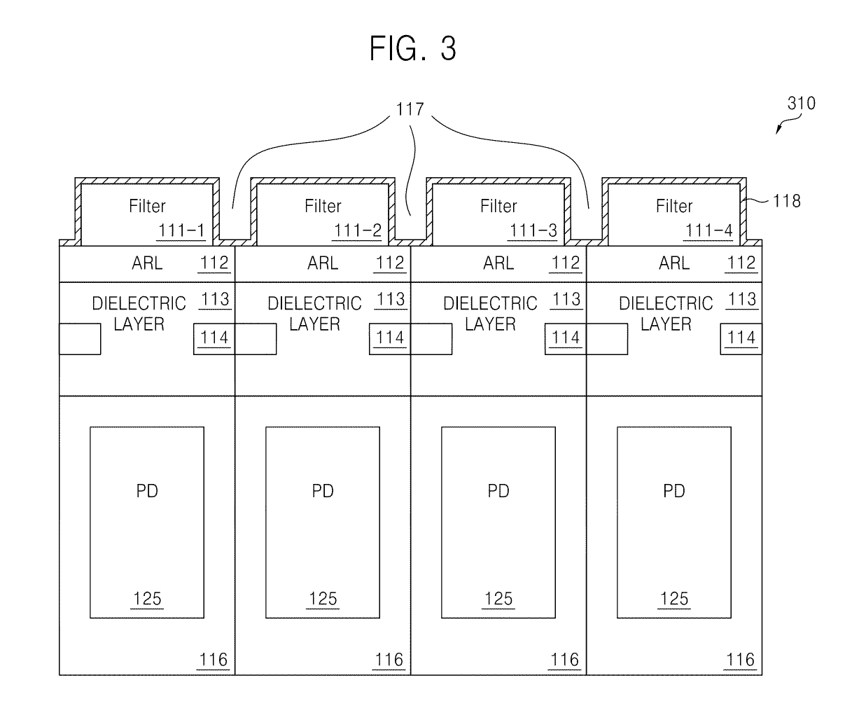

FIG. 3 is a cross-sectional view of a plurality of active pixels 310 included in the pixel array 110 of the image sensor 100 included in FIG. 1, according to some example embodiments of the inventive concept. The active pixels 310 illustrated in FIG. 3 are substantially the same as the active pixels 210 illustrated in FIG. 2 except for some elements. In detail, a passivation layer 118 is formed on the filters 111-1, 111-2, 111-3, and 111-4 and the ARL112. The passivation layer 118 is used to protect the filters 111-1,111-2, 111-3 and 111-4. According to an embodiment, the passivation layer 118 is formed on the filters 111-1, 111-2, 111-3, and 111-4.

The passivation layer 118 may be formed of a material having the index of refraction greater than that of the filters 111-1, 111-2, 111-3, and 111-4. The passivation layer 118 may be an oxide layer, a nitride layer, or a photoresist layer.

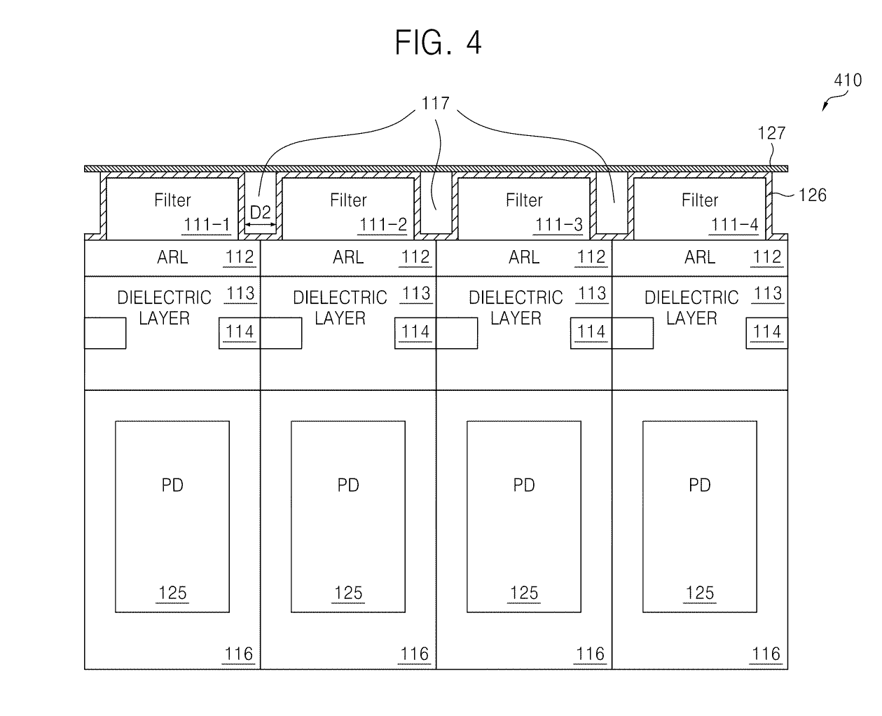

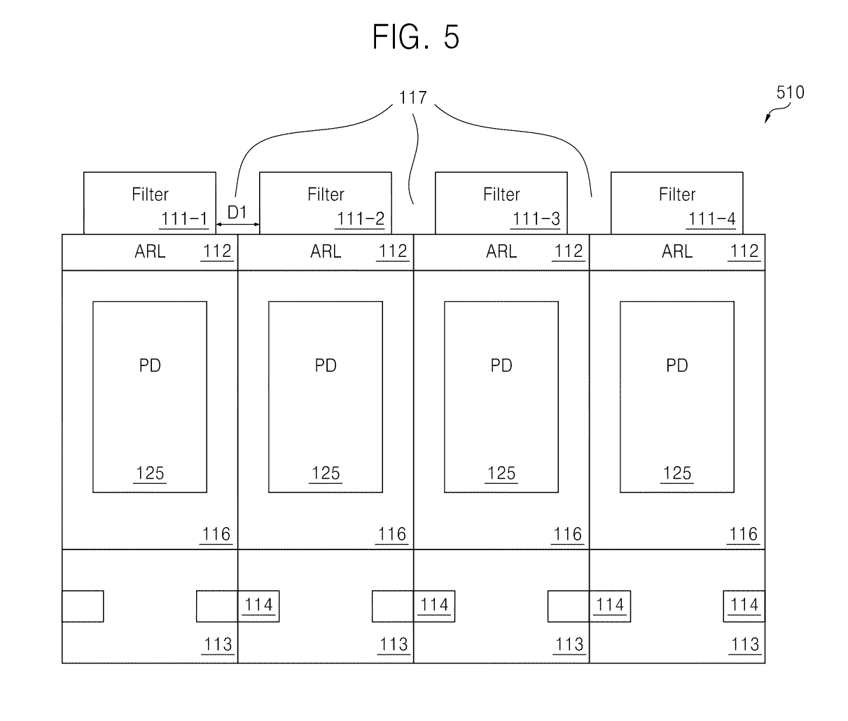

FIG. 4 is a cross-sectional view of a plurality of active pixels 410 included in the pixel array 110 of the image sensor 100 included in FIG. 1, according to some example embodiments of the inventive concept. The active pixels 410 illustrated in FIG. 5 are substantially the same as the active pixels 210 illustrated in FIG. 2 with the exception that a first passivation layer 126 is formed on the filters 111-1, 111-2, 111-3, and 111-4 and the ARL 112. The first passivation layer 126 is used to protect the filters 111-1,111-2, 111-3 and 111-4. According to an embodiment, the first passivation layer 126 is formed on the filters 111-1, 111-2, 111-3, and 111-4.

In addition, a second passivation layer 127 is formed on the first passivation layer 126. The second passivation layer 127 may be formed of a material having the index of refraction greater than that of the first passivation layer 126. The first passivation layer 126 and the second passivation layer 127 may be an oxide layer, a nitride layer, or a photoresist layer.

A width D2 of the air gap region 117 between the filters 111-1, 111-2, 111-3, and 111-4 may be at least 100 nm and at most 300 nm. The width D2 of the air gap region 117 may be 200 nm.

FIG. 5 is a cross-sectional view of a plurality of active pixels in the pixel array of the image sensor included in FIG. 1, according to some example embodiments of the inventive concept. The active pixels 510 illustrated in FIG. 5 indicate back side illuminated (BSI) type pixels.

Referring to FIGS. 1 and 5, the active pixels 510 include a plurality of filters 111-1, 111-2, 111-3, and 111-4, respectively, an ARL 112, a substrate 116 and a dielectric layer 113.

Each of the filters 111-1, 111-2, 111-3, and 111-4 is disposed on the ARL 112 to focus incident light. The filters 111-1, 111-2, 111-3, and 111-4 may be separated from one another by an air gap region 117. The index of refraction of the filters 111-1, 111-2, 111-3, and 111-4 is greater than that of the air gap region 117, i.e., air. For instance, when the index of refraction of the air gap region 117 is 1, the index of refraction of the filters 111-1, 111-2, 111-3, and 111-4 may be greater than 1 and not exceed 1.7. Because of the refraction difference between the air gap region 117 and the filter 111-1, 111-2, 111-3 or 111-4, the active pixels 510 do not require additional microlens to focus incident light.

A width D1 of the air gap region 117 formed between the filters 111-1, 111-2, 111-3, and 111-4 may be at least 100 nm and at most 300 nm. For example, the width D1 of the air gap region 117 may be 200 nm.

Since the functions of the components 112, 113, 114, 116, and 125 of FIG. 5 are similar to those of the components 112, 113, 114, 116 and 125 of FIG. 2, respectively, a detailed description thereof will be omitted.

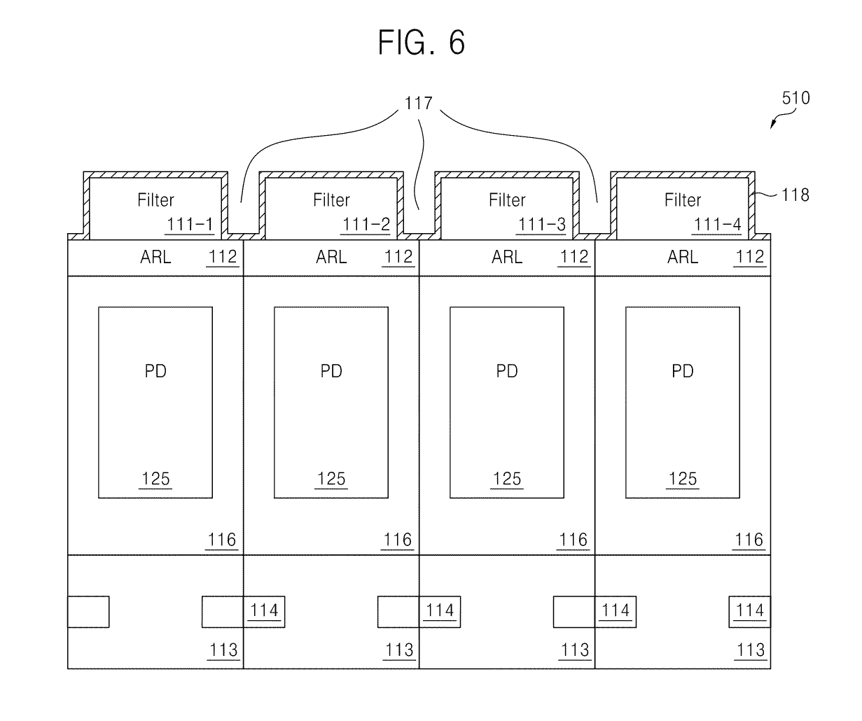

FIG. 6 is a cross-sectional view of a plurality of active pixels in the pixel array of the image sensor included in FIG. 1, according to some example embodiments of the inventive concept. The active pixels 610 illustrated in FIG. 6 indicate back side illuminated (BSI) type pixels.

The active pixels 610 illustrated in FIG. 6 are substantially the same as the active pixels 510 illustrated in FIG. 5 except for some elements. In detail, a passivation layer 118 is formed on the filters 111-1, 111-2, 111-3, and 111-4 and the ARL 112. The passivation layer 118 is used to protect the filters 111-1,111-2, 111-3 and 111-4. According to an embodiment, the passivation layer 118 is formed on the filters 111-1, 111-2, 111-3, and 111-4.

The passivation layer 118 may be formed of a material having the index of refraction greater than that of the filters 111-1, 111-2, 111-3, and 111-4. The passivation layer 118 may be an oxide layer, a nitride layer, or a photoresist layer.

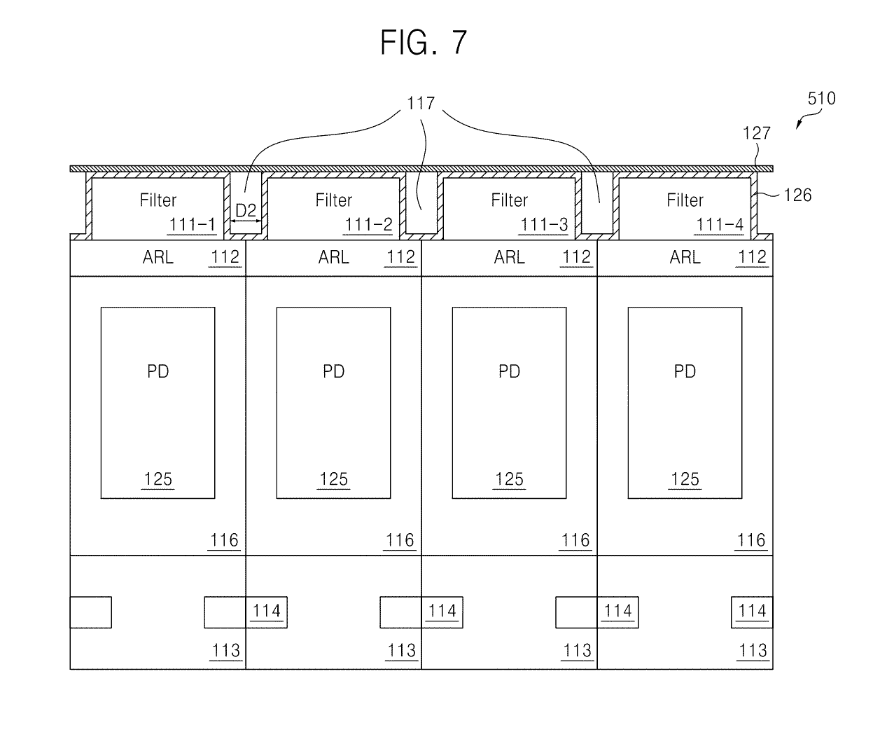

FIG. 7 is a cross-sectional view of a plurality of active pixels in the pixel array of the image sensor included in FIG. 1, according to some example embodiments of the inventive concept. The active pixels 710 illustrated in FIG. 7 indicate back side illuminated (BSI) type pixels.

The active pixels 710 illustrated in FIG. 7 are substantially the same as the active pixels 510 illustrated in FIG. 5 with the exception that a first passivation layer 126 is formed on the filters 111-1, 111-2, 111-3, and 111-4 and the ARL 112. The first passivation layer 126 is used to protect the filters 111-1,111-2, 111-3 and 111-4. According to an embodiment, the first passivation layer 126 is formed on the filters 111-1, 111-2, 111-3, and 111-4.

In addition, a second passivation layer 127 is formed on the first passivation layer 126. The second passivation layer 127 may be formed of a material having the index of refraction greater than that of the first passivation layer 126. The first passivation layer 126 and the second passivation layer 127 may be an oxide layer, a nitride layer, or a photoresist layer.

A width D2 of the air gap region 117 between the filters 111-1, 111-2, 111-3, and 111-4 may be at least 100 nm and at most 300 nm. The width D2 of the air gap region 117 may be 200 nm.

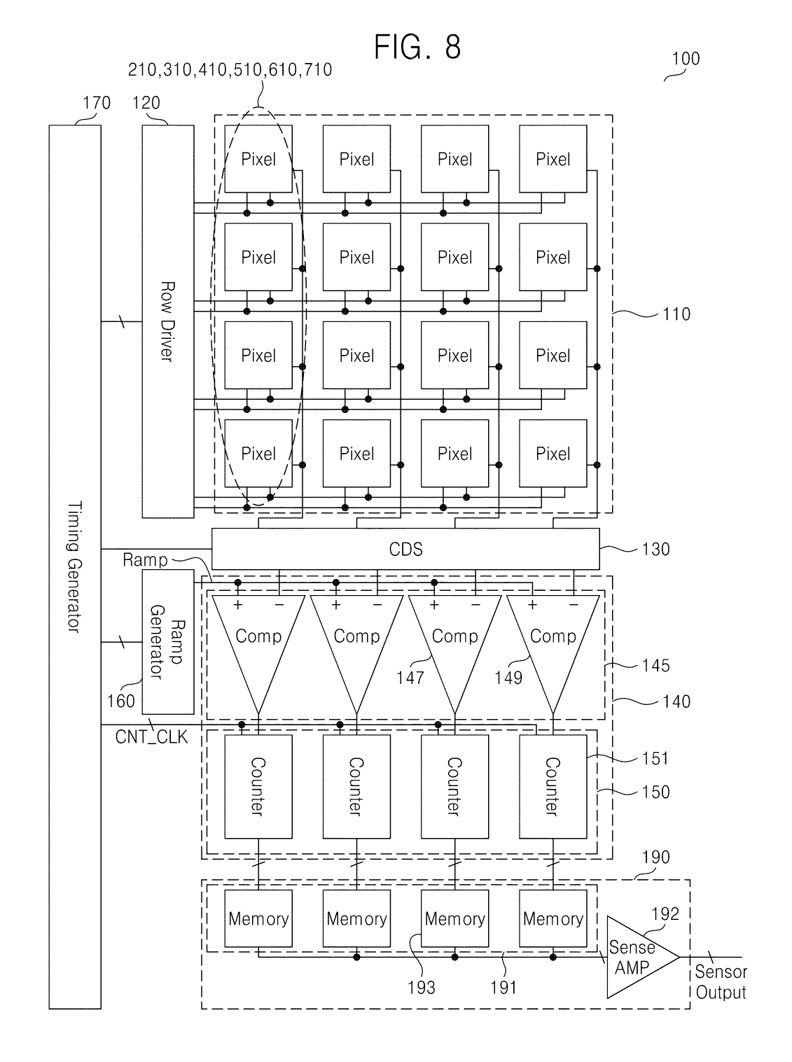

FIG. 8 is a detailed block diagram of the image sensor 100 illustrated in FIG. 1. Referring to FIGS. 1, 2, and 8, the timing generator 170 generates at least one control signal for controlling the operation of each of the row driver 120, the CDS block 130, the ADC block 140, and the ramp generator 160.

The control register block 180 generates at least one control signal for controlling the operation of each of the ramp generator 160, the timing generator 170, and the buffer 190. The control register block 180 operates under the control of the camera controller 201. The row driver 120 drives the pixel array 110 in units of rows. For instance, the row driver 120 may generate a selection signal for selecting one of a plurality of rows. Each of the rows includes a plurality of pixels.

The pixel array 110 includes a plurality of the active pixels 210, 310, 410, 510, 610, or 710. The simple arrangement of the active pixels 210, 310, 410, 510, 610, or 710 is illustrated in FIG. 8 for convenience' sake in the description, but the structure of the pixel array 110 is as shown in FIG. 2, 3, 4, 5, 6, or 7.

The active pixels 210, 310, 410, 510, 610, or 710 sense incident light and output an image reset signal and an image signal to the CDS block 130.

The CDS block 130 performs CDS on the image reset signal and the image signal. The ADC block 140 compares a ramp signal Ramp output from the ramp generator 160 with a CDS signal output from the CDS block 130, generates a comparison signal, counts level transition time of the comparison signal based on a clock signal CNT_CLK, and outputs a count result to the buffer 190.

Referring to FIG. 8, the ADC block 140 includes a comparison block 145 and a counter block 150.

The comparison block 145 includes a plurality of comparators 147 and 149. The comparators 147 and 149 are connected with the CDS block 130 and the ramp generator 160. An output signal of the CDS block 130 is input to a first input terminal (e.g., a negative (−) input terminal) of each of the comparators 147 and 149 and the ramp signal Ramp output from the ramp generator 160 is input to a second input terminal (e.g., a positive (+) input terminal) of each of the comparators 147 and 149.

The comparators 147 and 149 receive and compare the output signal of the CDS block 130 with the ramp signal Ramp received from the ramp generator 160 and outputs a comparison signal. For instance, the comparison signal output from the first comparators 147, which compare a signal output from each of the active pixels 210, 310, 410, 510, 610, or 710 with the ramp signal Ramp, may correspond to a difference between the image reset signal and the image signal varying with the illumination of incident light.

The ramp generator 160 may operate under the control of the timing generator 170.

The counter block 150 includes a plurality of counters 151. The counters 151 are respectively connected to output terminals of the respective comparators 147 and 149. Each counter 151 counts the level transition time of the comparison signal according to the clock signal CNT_CLK received from the timing generator 170 and outputs a digital signal, i.e., a count value. In other words, the counter block 150 outputs a plurality of digital image signals.

The counter 151 may be implemented by an up/down counter or a bit-wise inversion counter.

The buffer 190 stores digital image signals output from the ADC block 140, and senses and amplifies them.

The buffer 190 includes a memory block 191 and a sense amplifier 192.

The memory block 191 includes a plurality of memories 193 that respectively store count values respectively output from the counters 151. The count values include count values related with signals output from the active pixels 210, 310, 410, 510, 610, or 710. The sense amplifier 192 senses and amplifies the count values output from the memory block 191.

The image sensor 100 outputs image data to the DSP 200.

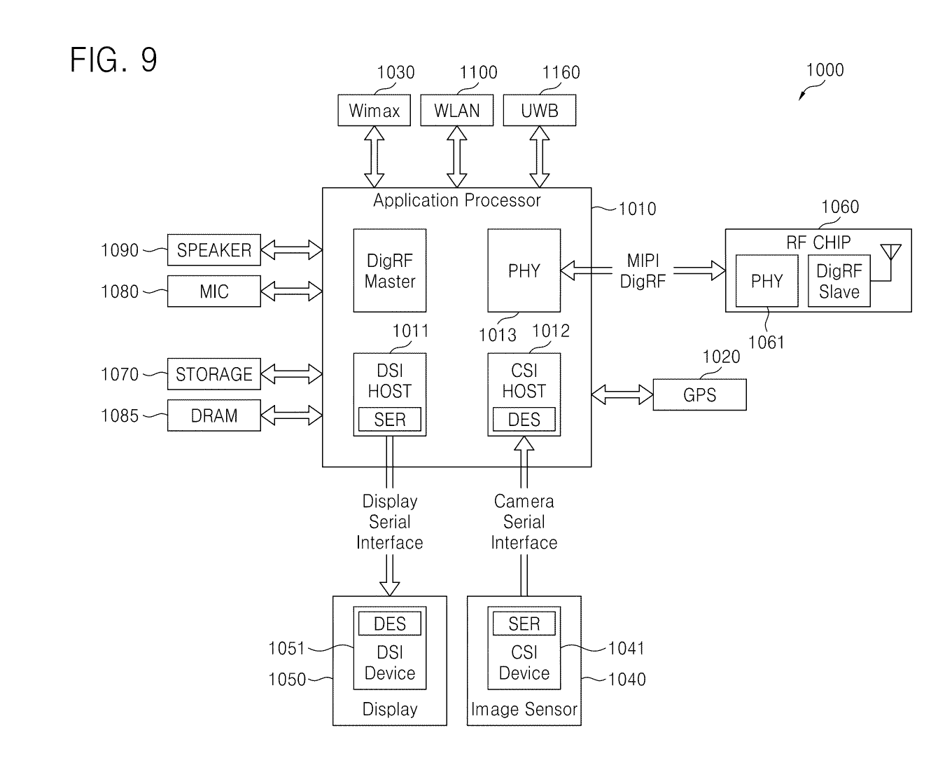

FIG. 9 is a schematic block diagram of an image processing system 1000 including an image sensor 1040 according to some example embodiments of the inventive concept. The image processing system 1000 may be implemented as a data processing device, such as a personal digital assistant (PDA), a portable media player (PMP), or a mobile communication device such as a mobile phone or a smart phone, which can use or support mobile industry processor interface (MIPI®). The image processing system 1000 may be also implemented as a portable device such as a tablet computer.

The image processing system 1000 includes an application processor 1010, the image sensor 1040, and a display 1050.

A camera serial interface (CSI) host 1012 implemented in the application processor 1010 may perform serial communication with a CSI device 1041 included in the image sensor 1040 through CSI. The image sensor 1040 includes the active pixels 210, 310, 410, 510, 610, or 710 illustrated FIG. 2, 3, 4, 5, 6, or 7. A display serial interface (DSI) host 1011 implemented in the application processor 1010 may perform serial communication with a DSI device 1051 included in the display 1050 through DSI.

The image processing system 1000 may also include a radio frequency (RF) chip 1060 communicating with the application processor 1010. A physical layer (PHY) 1013 of the application processor 1010 and a PHY 1061 of the RF chip 1060 may communicate data with each other according to Mobile Industry Processor Interface (MIPI) DigRF.

The image processing system 1000 may further include a global positioning system (GPS) 1020, a data storage device 1070, a microphone (MIC) 1080, a memory 1085 (like dynamic random access memory (DRAM)), and a speaker 1090. The image processing system 1000 may communicate using a worldwide interoperability for microwave access (Wimax) 1030, a wireless local area network (WLAN) 1100, and an ultra-wideband (UWB) 1160.

As described above, according to some example embodiments of the inventive concept, an image sensor does not require additional microlens, thereby reducing crosstalk. As a result, a signal-to-noise ratio (SNR) is increased.

While some example embodiments of the inventive concept have been particularly shown and described, it will be understood by those of ordinary skill in the art that various changes in form and details may be made therein without departing from the spirit and scope of the present invention as defined by the following claims.

What is claimed is:

1. An image sensor, comprising:
a plurality of filters; and
an air gap region positioned between the plurality of filters,
wherein an index of refraction of each of the filters is greater than an index of refraction of the air gap region.

2. The image sensor of claim 1, further comprising:
a first passivation layer formed on the filters to protect the filters.

3. The image sensor of claim 2, wherein the first passivation layer has an index of refraction greater than the index of refraction of the filters.

4. The image sensor of claim 2, wherein the first passivation layer is an oxide layer, a nitride layer, or a photoresist layer.

5. The image sensor of claim 1, wherein the air gap region has widths greater than or equal to 100 nm and less than or equal to 300 nm.

6. The image sensor of claim 1, wherein the image sensor does not include microlens.

7. The image sensor of claim 2, further comprising:
a second passivation layer formed on the first passivation layer.

8. The image sensor of claim 7, wherein the second passivation layer has an index of refraction greater than the index of refraction of the filters.

9. The image sensor of claim 7, wherein the second passivation layer is an oxide layer, a nitride layer, or a photoresist layer.

10. The image sensor of claim 1, wherein the air gap region has widths less than or equal to 300 nm.

11. The image sensor of claim 1, wherein the index of refraction of the air gap region is 1.

12. The image sensor of claim 1, wherein the index of refraction of the filters is greater than 1.

13. The image sensor of claim 1, wherein the index of refraction of the filters is less than or equal to 1.7.

14. An image processing system, comprising:
an image sensor; and
a processor configured to control operation of the image sensor,
wherein the image sensor comprises,
a plurality of filters; and
an air gap region positioned between the plurality of filters,
wherein an index of refraction of each of the filters is greater than an index of refraction of the air gap region.

15. The image processing system of claim 14, wherein the image processing system is a portable device.

16. The image processing system of claim 14, wherein the image processing system is a mobile communication device.

17. The image processing system of claim 14, wherein the image sensor further comprises,
a first passivation layer formed on the filters to protect the filters.

18. The image processing system of claim 17, wherein the image sensor further comprises,
a second passivation layer formed on the first passivation layer.
